(19) United States
(12) Patent Application Publication
(10) Pub. No.: US 2025/0037234 A1
(43) Pub. Date: Jan. 30, 2025

(54) METHOD FOR IMAGING A SURFACE OF A TURBOMACHINE AND DETECTING DAMAGE

(71) Applicant: MTU Aero Engines AG, München (DE)

(72) Inventors: Maximilian Buchstab, Schwülper (DE); Jörn Städing, Lindwedel (DE); Kolja Hedrich, Garbsen (DE); Eduard Reithmeier, Garbsen (DE); Philipp Middendorf, Garbsen (DE)

(73) Assignee: MTU Aero Engines AG, München (DE)

(21) Appl. No.: 18/682,558

(22) PCT Filed: Jul. 28, 2022
(86) PCT No.: PCT/DE2022/100544

§ 371 Date: Sep. 12, 2024

(30) Foreign Application Priority Data
Aug. 11, 2021 (DE) 10 2021 120 899.8

(51) Int. Cl. G06T 3/4038; G06T 7/00

(52) U.S. Cl. CPC G06T 3/4038; G06T 7/0004; G06T 2207/20084; G06T 2207/30164

(57) ABSTRACT

The present invention relates to a method for imaging a surface in an internal space of an axial turbomachine, wherein the surface is captured in a sequence using an imaging device, i.e.—only a portion is captured with the imaging device at a respective time, thus generating only a partial image of the surface; the imaging device and the surface are moved relative to each other such that different portions of the surface are captured over the course of time, thus generating different partial images, and wherein the partial images are stitched together to produce an image of the surface.

### BACKGROUND OF THE INVENTION

The present invention relates to a method for imaging a surface in an inner space of a turbomachine as well as for detecting any damage in the surface.

An axial turbomachine is divided functionally into a compressor, a combustion chamber, and a turbine, whereby in the case of an aircraft engine, air intake is compressed in the compressor and undergoes combustion with admixed kerosene in the downstream combustion chamber. The hot gas formed, a mixture of combustion gas and air, flows through the downstream turbine and undergoes expansion there. As a rule, the turbine and the compressor are each multistage in construction, with a respective stage comprising a stator and a rotor. The stators and rotors are hereby each constructed from a plurality of blades, which are arranged in circumferential succession one after the other and around which, depending on the application, streams a flow from the compressor or from the hot gas.

In the course of utilization, damage, that is, damaged sites, can arise on various components. The components arranged in the gas channel, such as, for example, the airfoils themselves or else the inner and outer running surfaces and gas channel plates, are particularly in danger and are of relevance to safety. These components are provided multiple times with protective coatings, which, for example, are attacked or can suffer wear, such as, for instance, abrasive or thermal wear, etc., in the course of utilization. A particularly advantageous area of application lies in the examination of such a surface in the course of engine reinspection, but, in general, the subject is not to be limited to this.

### SUMMARY OF THE INVENTION

The present invention is based on the technical problem of specifying an advantageous method for imaging a surface in an internal space of an axial turbomachine and an advantageous method for detecting as well as preferably also quantifying damage in the surface.

This problem is solved in accordance with the invention by the imaging method as well as by the method for detecting damage of the present invention. The imaging of the surface occurs using an imaging device, which, for example, depending on the position of the surface, can be introduced for this purpose into the gas channel axially from the front or rear (for example, front stage of a low-pressure compressor or last stage of a low-pressure turbine) or preferably via special borescope inspection ports (BSI ports). By use of the imaging device, the surface is then imaged in a sequence, whereby the imaging device captures only a portion of the surface at a respective point in time, that is, it does not capture the entire surface. Accordingly, only a partial image is generated in each instance; that is, only the respective partial region is imaged. Over the course of time, however, the imaging device and the surface are moved relative to each other; that is, they are brought into different relative positions, in which different partial regions of the surface are captured, thereby forming partial images, that is, different partial regions. The partial images captured in this way are stitched together to produce a larger image or total image of the surface. Therefore, the partial regions that are sequentially imaged in the course of the capture then lie in an image as adjacent or overlapping image regions.

Summarized more simply, the surface is not captured with a single image, but rather is captured over the course of time. That is, a video recording of the surface is more or less generated. The individual images thereof, that is, the partial images that each image only a partial region of the surface, are afterwards stitched together to produce a surface. In comparison to a direct evaluation of the video recording, this can enable a more objective evaluation, for example, because individual surface regions, in which damage or, in general, departures from a desired surface appearance, for example, may be present, can be classified more objectively relative to the larger surface or total surface. This also applies, in general, to a visual inspection by operating personnel, but, in particular, in the case of a further automated evaluation.

Preferred embodiments are found in the dependent claims and in the entire disclosure, whereby, in the description of the features, a distinction is not always made in detail between method aspects and use or device aspects; in any case, the disclosure is to be read implicitly in terms of all claim categories.

The stitching of the partial images is a computer-implemented method; this method step is therefore executed in a computer-based manner. This can occur, for example, using an external computer, into which the sequence of the partial images (the “video”) is input after the capture thereof. On the other hand, it is also possible for a control unit of the imaging device and the computer-based stitching to be designed in an integrated manner; that is, for example, the partial images can be fed directly to the stitching while the image is being generated. Regardless of these details, the stitching can comprise, in particular, an adding-up of the partial images, that is, of the overlapping regions. This can occur using a commercially available software or else a freely available stitching software, such as, for example, AutoStitch (using the SIFT algorithm), or using open-source algorithms, such as, for example, Oriented FAST and rotated BRIEF (ORB), which then can also be used, for example, as a combined tool for feature tracking.

As already mentioned, use of the present method preferentially images a surface that faces the gas channel or the imaging device is arranged in the gas channel for the imaging. As imaging device, it is possible to provide an endoscope, which, in general, can also be rigid, but is preferably flexible in design, in particular a video endoscope. In general, the surface can also lie, for example, in the combustion chamber, but it is preferably arranged in an engine stage of the turbine or, in particular, in the compressor, in particular, the high-pressure compressor. Preferably, the surface can be formed by a coating, in particular, a thermal protective coating.

The surface can preferentially be a wall surface that radially bounds the gas channel and, for example, is at least or preferably rotationally symmetrical around the longitudinal axis of the turbomachine. The latter can be advantageous, for example, in regard to the complexity or computational effort involved when the partial images are stitched together. On the other hand, especially such a (partially) surrounding surface can otherwise be captured only in a limited manner or else not at all by way of a single imaging. Particularly preferably, the surface can involve a running surface of the engine stage, along which the blades or vanes sweep during operation, in particular a rotor drum that bounds the gas channel radially inward.

In accordance with a preferred embodiment, the surface for the relative movement is moved as viewed in a fixed coordinate system, with the imaging device preferably being stationary (not moving as viewed in the fixed coordinate system). The surface can be moved, in particular, by way of a rotational movement around a longitudinal axis of the turbomachine that coincides with a rotational axis of the rotor stages thereof. Thus, for example, the running surface can be rotated around the longitudinal axis and, accordingly, successively passed by the imaging device or the capturing area thereof, which, for example, in the case of the rotor drum, is directed radially inward.

In a preferred embodiment, during the relative movement, positional data relating to the relative positions are captured; that is, the data set of a respective partial image can be supplemented by the data relating to the corresponding relative position of the imaging device and the surface at the point in time of the imaging. These positional data can then be used when the partial images are stitched together and thus can simplify the assignment as to the position of the stitched image at which a respective partial image is to be inserted. In the preferred case of rotational movement around the longitudinal axis, the positional data can involve angles of rotation, so that the partial images can then be stitched together in the sequence of their angles of rotation.

In accordance with a preferred embodiment, the stitching together of the partial images occurs by a feature extraction and feature tracking; that is, optical features are identified in the partial images and matched in other partial images, that is, tracked throughout the partial images. These features can involve, for example, edges or corners or, for example, also regions that are differentiated from the surrounding surface by a certain surface quality (texture or the like). In detail the feature tracking can occur, for example, by the ORB, SIFT, or SURF methodology, which is available as a tool in the image processing library OpenCV, for example. The stitching together by feature tracking can be an alternative to resorting to the positional data; preferably, however, the two of them can be combined with each other.

In a preferred embodiment, prior to the stitching, at least some partial images are adapted by way of a coordinate transformation; that is, the partial images are aligned geometrically with respect to one another by transforming them using a transformation parameter. In regard to the sequence of the procedure, therefore, an image registration can occur after the feature tracking before the partial images are then stitched together. The image registration can occur, for example, by the brute force methodology or the FLANN methodology, for example, both of which are available as tools in OpenCV. In general, it is possible for a preprocessing of the images to compensate for varying surrounding conditions, such as, for example, camera position and also illumination, and, in this way, to make the application of the algorithm more robust.

In accordance with a preferred embodiment, the stitched image will be or is imaged on a plane, that is, is flat. In general, this can also occur after the stitching; however, preferably, partial images are already each imaged on a plane and afterwards stitched together. In the case of the rotationally symmetrical surface, which can be rotated around the longitudinal axis during the imaging (see above), the cylindrical shape is therefore converted into a planar shape; in pictorial terms, it is therefore possible to “roll up” the surface of the rotor drum. Alternatively, however, it is also possible to transform the partial images into the cylindrical shape in order to take into account or to reduce possible distortions, for example.

As already mentioned, the invention also relates to a detecting method, wherein a surface in an internal space of the turbomachine is first imaged in a presently disclosed way and then the image that is stitched together from the partial images is examined for damage. The damage can hereby comprise one damaged site or else a plurality of damaged sites; that is, the damaged sites need not necessarily be contiguous, but rather can also be present is various partial regions. It is also possible for flakes, cracks, or else discolorations to be involved, depending on the kind of surface and the utilization.

As explained at the beginning, the sequential capture of the surface in the form of a video in partial images in connection with the stitching during the detection of damage can also be advantageous on account of the objectification capability, among other things. It is therefore possible to view in its entirety a surface that is not accessible “at one glance,” thereby making possible a better classification of the damage in regard to, for example, the proportion of damage or the extent of damage as well as the position of damage.

The application can be particularly advantageous in the case of a protective coating, in particular a thermal protective coating. Every degree of damage need not necessarily hereby lead to a full reinspection of the turbomachine, in particular the aircraft engine, but rather such a reinspection can be ordered only when a certain threshold value, that is, a defined proportion of the surface, has been exceeded. In this case, the accuracy and the objectification come into effect advantageously, because, on the one hand, a safety-relevant extent of damage is recognized and, on the other hand, a full reinspection is also not ordered without a reason.

In general, an application in the course of the initial manufacture of the turbomachine, in particular the aircraft engine, is also conceivable. The imaging method or detecting method can occur, for example, during a final quality control prior to delivery. The stitched image can also be kept easily for purposes of documentation and can later be used, for example, as a reference (simpler than a video, for example). In a preferred embodiment, the imaging or detection occurs in the course of a reinspection of the turbomachine, in particular the aircraft engine. After a certain number of hours of operation, therefore, the surface is imaged and inspected and, depending on this, a decision can then be made on the further course of action (further operation or full reinspection).

In accordance with a preferred embodiment, the image of the surface obtained by stitching is examined by an artificial neural network; that is, the detection of damage occurs by way of or with the aid of an appropriately trained algorithm (machine learning). It is hereby possible for a convolutional neural network (CNN), that is, a particularly suitable neural network for machine image processing (for example, one having an encoder-decoder structure), to find application. It is hereby possible to resort to commercial or freely available network architectures and training methods that are known as such (compare, for example, Li, Hanchao, et al. “Pyramid attention network for semantic segmentation,” arXiv preprint arXiv: 1805.10180 2018, and He, Kaiming, et al. “Deep residual learning for image recognition,” Proceedings of the IEEE conference on computer vision and pattern recognition. 2016). After training has occurred using appropriate image data, the network can then also differentiate between, for example, damage due to dirt contamination or (uncritical) discoloration. The evaluation by an appropriately trained artificial neural network (in particular, CNN) also makes it possible to achieve, for example, a high accuracy in segmentation of the damage.

In accordance with a preferred embodiment, the stitched image is used to determine a surface proportion that has been affected by the damage. By a pixeled segmentation of the damage, it is possible, for example, for a calculation of the damaged surface per partial image and in sum total to occur. In summary, the algorithmics can comprise an image processing, a positional assignment, and a segmentation.

In a preferred embodiment, the damage is classified, whereby the classification criteria can be, for example, the age of the damage and/or the manifestation of the damage and/or the (largest) contiguous damaged surface or its proportion of the total surface. A differentiation can also be made, for example, according to the kind of damage, such as, for instance, between a rather flat flake and a crack.

The invention also relates to the use of a computer program product in a presently disclosed method, in particular for the stitching and the preparative image processing and/or the subsequent image processing by a neural network.

### BRIEF DESCRIPTION OF THE DRAWING FIGURES

The invention will be explained in detail below on the basis of an exemplary embodiment, whereby the individual features in the scope of the dependent claims can also be of essence to the invention in other combinations and, moreover, no distinction is made in detail between the different claim categories.

Shown in detail are

FIG. 1 a turbomachine, namely, an aircraft engine, in a schematic axial section;

FIG. 2 a surface in an internal space of the turbomachine in accordance with FIG. 1 in a schematic radial view;

FIG. 3 a schematic diagram relating to the procedure in accordance with the invention for the imaging of a surface and the detection of damage in accordance with FIG. 2;

FIG. 4 a flow chart as overview of the method steps performed in the imaging and the detection of damage.

### DESCRIPTION OF THE INVENTION

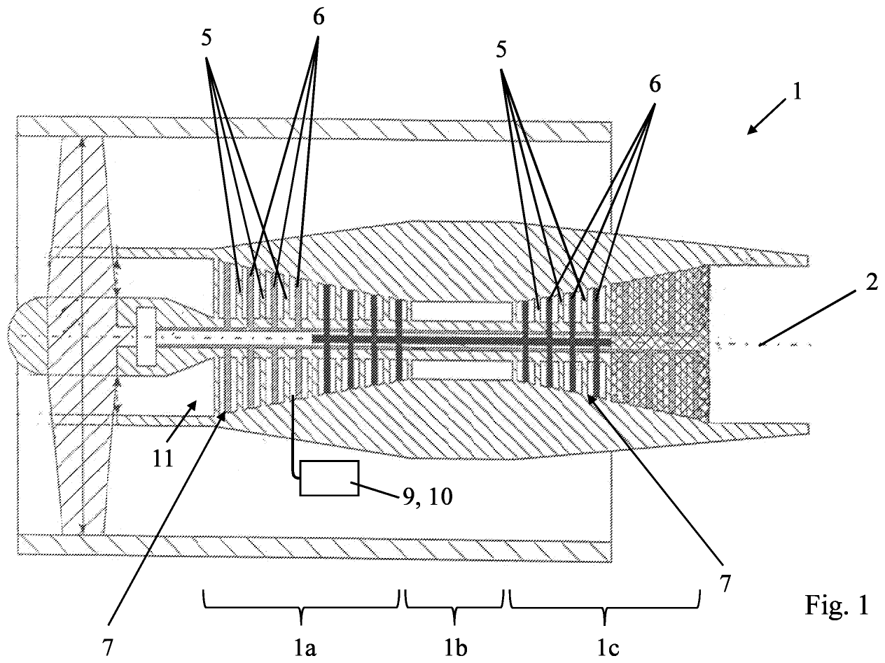

FIG. 1 shows a turbomachine 1, specifically a turbofan engine, in an axial section. The turbomachine 1 is divided functionally into a compressor 1a, a combustion chamber 1b, and a turbine 1c. Both the compressor 1a and the turbine 1c are each constructed of a plurality of stages. Each of the stages is composed of a stator 5 and a rotor 6. The reference number 7 refers to the gas channel, that is, the compressor gas channel in the case of the compressor 1a or the hot-gas channel in the case of the turbine 1c. In the compressor gas channel, the air intake is compressed and then undergoes combustion with admixed kerosene in the downstream combustion chamber 1b. The hot gas flows through the hot-gas channel and thereby drives the rotors 6, which rotate around the longitudinal axis 2.

The present subject is directed at, in particular, the reinspection of such an engine, that is, an inspection after a certain period of operation. This can occur on the assembled engine and on the engine found in the aircraft, to which end, for example, for an inspection in the compressor region, as illustrated schematically here, an imaging device 9, namely, an endoscope 10, is introduced and fixed in place in the internal space 11, that is, in the present case, the compressor gas channel, by way of a special endoscope port.

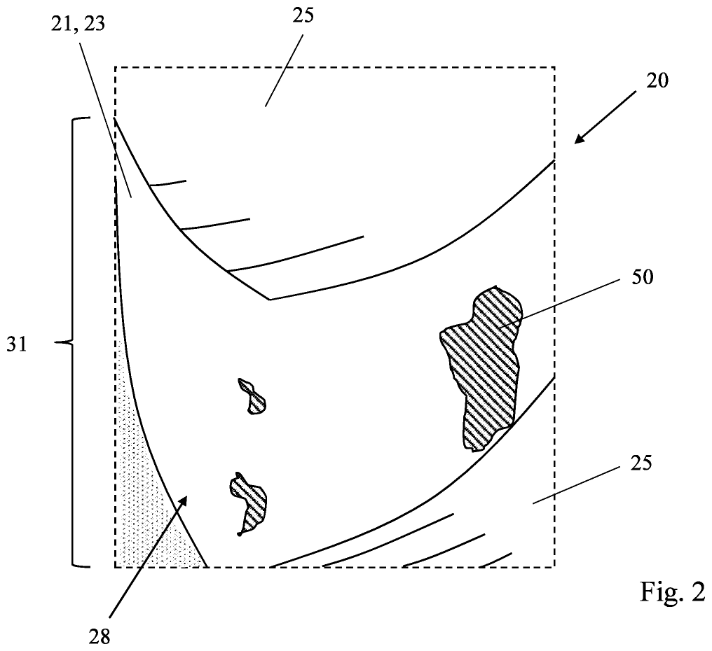

FIG. 2 shows in schematic illustration a partial image 20, captured in this way, of a surface 21, which, in the present case, is a running surface 23 that bounds the gas channel 7 radially inward. The direction of view is radial from outward to inward. To be seen, furthermore, are airfoils 25, around which, during operation, a flow of compressor gas streams and which sweep along the running surface 23. Overall, the surface 21, which is formed by a thermal protective coating 28, has a cylindrical shape around the longitudinal axis 2, with, in FIG. 2, only a partial region 31 of it being seen. In the present method, the imaging device 9 can be positioned between two airfoils 25 (of a stator 5) and the surface 21 can be moved past below by rotation of the rotor 6 (for example, semi-automatically with an unsteady movement).

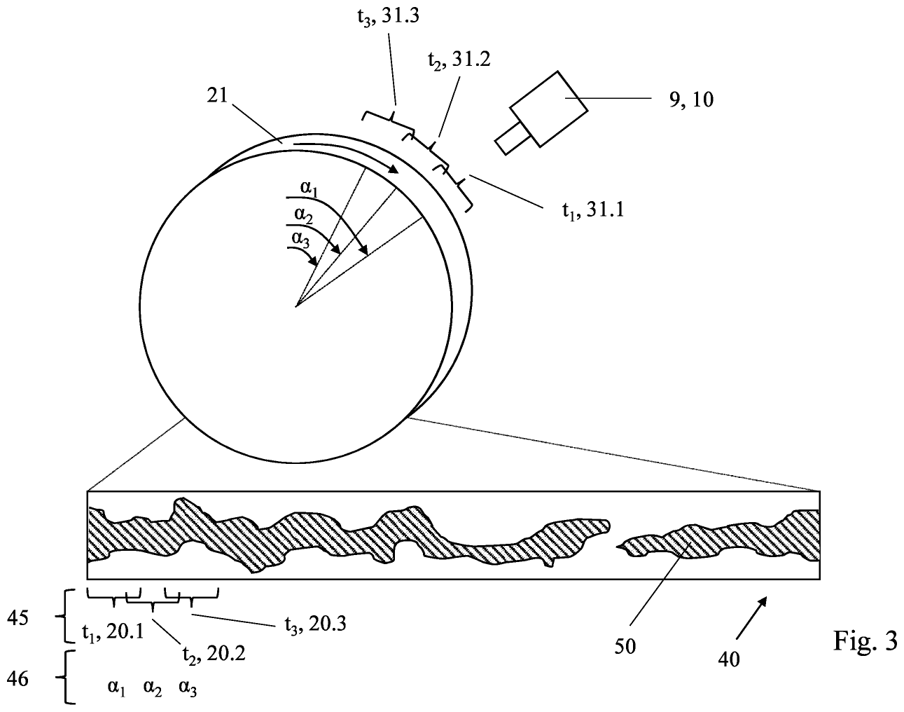

FIG. 3 illustrates schematically how, at a respective point in time t₁₋₃, the imaging device 9 can be used in each instance to image only a partial region 31.1-31.3. In the present instance, the imaging device 9 and the surface 21 are moved relative to each other such that the surface 21 is rotated as viewed in a stationary coordinate system and the imaging device 9 is stationary, so that different partial regions 31.1-31.3 of the surface 21 are captured in a sequence 45 of partial images 20.1-20.3. During the relative movement, positional data 46 are also captured, which, in the present case, consist of angles of rotation α₁-α₃, which, when the partial images 20.1-20.3 are stitched together, that is, when a respective partial image 20.1-20.3 is positioned, are also incorporated at the proper site. Overall, an image 40 of the entire surface 21 is generated in this way. To this end, the partial images 20.1-20.3 that are generated at a respective point in time t₁₋₃ from the respective partial region 31.1-31.3 are stitched together; namely, they are joined to one another by stitching.

In the resulting image 40, it is then possible, for example, to evaluate or to detect a damage 50 in the surface 21 and it is possible, in particular, to determine relatively precisely the surface proportion thereof relative to the total surface. Depending on a threshold value, it is then possible, for example, to determine whether further operation is still possible or whether the engine needs to be taken out of service for an overhaul. The image analysis can occur, in particular, using an artificial neural network, such as, for example, a convolutional neural network. The latter is trained beforehand with appropriate training data and therefore learns how to distinguish a damage (for example, flakes or a crack) from artifacts or residues of the imaging (cast shadow, etc.).

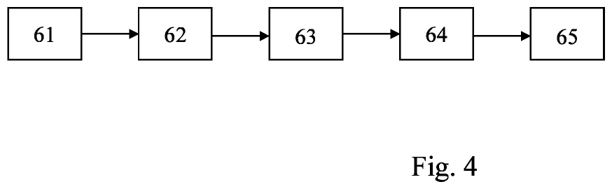

FIG. 4 summarizes the procedure in a flowchart 60. First of all, the surface 21, as depicted above, is captured 61; that is, it is captured in sequential form or in the form of a video. Subsequently, a feature extraction and feature tracking 62 occurs in the course of a processing of the partial images, whereby a correspondence of the feature points extracted in the partial images is then produced. In addition, it is hereby possible for the positional data also to be incorporated. Subsequently, a registration 63 is performed; that is, the partial images are geometrically transformed and accordingly adapted to one another. Afterwards, they are stitched together in the stitching 64, so that the stitched image results (compare FIG. 3). The resulting image is then utilized for detecting damage, which can occur, among other things, with the assistance of an artificial neural network 65. Alternatively to this sequence, it is also conceivable that a detection of damage is performed by the or a neural network 65 prior to the image processing (feature extraction and feature tracking 62, image registration 63, and stitching 64), for example, because, in the case of a totally damage-free surface, no further evaluation whatsoever and, in particular, no quantification are required.

1. A method for imaging a surface in an internal space of a turbomachine, comprising the steps of:
capturing the surface using an imaging device in a sequence wherein
at a respective point in time, only a partial region is captured using the imaging device, and only a partial image of the surface is generated;
the imaging device and the surface are moved relative to each other, so that, over the course of time, different partial regions of the surface are captured and different partial images are generated, and
stitching together the partial images to produce an image of the surface.

2. The method according to claim 1, wherein the internal space is a gas channel of the turbomachine and the surface is a running surface of an engine stage, wherein the running surface radially bounds the gas channel.

3. The method according to claim 1, wherein, when the imaging device and the surface are moved relative to each other, the imaging device, as viewed in a fixed coordinate system, is stationary and the surface is rotated with a rotational movement around a longitudinal axis of the turbomachine.

4. The method according to claim 1, wherein, when the imaging device and the surface are moved relative to each other, positional data, assigned to the respective partial image, are captured in regard to a respective relative position and wherein the positional data are incorporated when the partial images are stitched together.

5. The method according to claim 3, wherein the positional data are angles of rotation.

6. The method according to claim 1, wherein, for the stitching together of the partial images with a feature extraction and feature tracking, a feature is determined in one of the partial images and other partial images are matched to this feature.

7. The method according to claim 6, wherein, for the stitching together of the partial images, at least some of the partial images are adapted by a coordinate transformation.

8. The method according to claim 1, wherein the stitched image is imaged on a plane.

9. A method for detecting damage in a surface in an internal space of an axial turbomachine in a method according to claim 1, an image of the surface is generated and the image is examined for the damage.

10. The method according to claim 9, wherein the surface is formed by a thermal protective coating.

11. The method according to claim 9, wherein the detection of the damage occurs in the course of a reinspection of the turbomachine.

12. The method according to claim 9, wherein the image of the surface is examined by an artificial neural network.

13. The method according to claim 9, wherein a surface proportion that the damage occupies in the surface is determined from the image.

14. The method according to claim 9, wherein, on the basis of the image, a classification of the damage is generated, which is governed by at least either the age of the damage or the manifestation of the damage.

15. Use of a computer program product that comprises commands, which, during the execution of the program by a computer, cause it to join the partial images by stitching in accordance with the method of claim 1.

16. The method according to claim 4, wherein the positional data are angles of rotation.
